(19) United States
(12) Patent Application Publication
(10) Pub. No.: US 2015/0058448 A1
(43) Pub. Date: Feb. 26, 2015

(54) INTERNET VIDEO STREAMING SYSTEM

(71) Applicant: JOSH PROCTOR, Henderson, NV (US)

(72) Inventor: JOSH PROCTOR, Henderson, NV (US)

(21) Appl. No.: 13/972,774

(22) Filed: Aug. 21, 2013

(51) Int. Cl. H04L 29/06

(52) U.S. Cl. CPC H04L 65/607
USPC 709/219

(57) ABSTRACT

The present invention is an Internet video streaming system. Users create video and upload the video to a remote computer system. The system aggregates a set of related video feeds into events, which may be determined by metadata associated with the video feeds. The video feeds and/or events are combined with the user's other social media sites. Real-time chat is provided so that users may discuss the video feeds in real time. Information from the video metadata and/or chat is used to display targeted advertisements to the user. The remote computer system re-encodes the uploaded video data into one or more different formats. The system determines the amount of bandwidth available to each user and adjusts the quality of the encoded video stream to maximize bandwidth usage without exceeding latency limits.

### BACKGROUND OF THE INVENTION

(1) Field of the Invention

The present invention relates to an Internet video streaming platform and method that allows multiple concurrent users to send and receive video in a manner that makes efficient use of available network data throughput and aggregates related video feeds in one easy-to-use location.

Portions of this patent document contain material that is subject to copyright protection. The copyright owner has no objection to the facsimile reproduction by anyone of the patent document or the patent disclosure as it appears in the Patent and Trademark Office file or records, but otherwise reserves all copyrights whatsoever.

(2) Background of the Invention

Internet video streaming technology allows people to watch video from a desktop or laptop computer system, a mobile phone, a tablet computer, or other Internet-connected device. Streaming sends only a small portion of the video data to the device at a time (for example, only the next ten seconds of video). Streaming thus avoids the need to download a complete video file before beginning playback, minimizing the delay between selecting “play” and the start of playback. Streaming also minimizes the storage space required for the video data, which may be limited on certain devices, such as mobile devices. Further, in the case of live streaming video, there may not be a well-defined “video file” to download because the video data is created and broadcast to viewers continuously and without end. Consequently, various types of Internet video streaming technologies have been developed for these purposes.

Prior art Internet video streaming systems include YouTube, Netflix and Google Hangouts, among others. Types of video that are streamed include film, television, news, sporting events, home video, and videoconferences. Increasingly, any person with a camera-equipped Internet-connected mobile device can create and broadcast video to viewers all over the world, providing live coverage of events as they occur. Some events, such as public speeches, award ceremonies, or political rallies, may have tens or even hundreds of individuals each broadcasting from their own unique perspective.

These types of prior art Internet video streaming systems can be difficult to use for live, user-created video broadcasting because of limited content aggregation features. Thus, while a group of people can schedule and hold a videoconference, the prior art does not allow people (who may not know each other or have ever met) to broadcast live video and dynamically aggregate related video feeds in one easy-to-use location. Relatedly, broadcasting live video can require a great degree of technical knowledge with prior art technologies. Further, technical limitations such as network bandwidth and processing power can limit the number of concurrent video streams with prior art technologies. Therefore, there is a need for an Internet video streaming system that allows individuals to easily create and broadcast video content over the Internet in a way that allows that content to reach as many viewers as possible.

### BRIEF SUMMARY OF THE INVENTION

The present invention is an Internet video streaming system. In one or more embodiments, the invention provides user interfaces that allow a user to create video and upload the video to a remote computer system. In one or more embodiments, the invention aggregates a set of related video feeds into events. In one or more embodiments, these events are determined by metadata associated with the video feeds, such as tags, keywords, GPS coordinates, or content analysis of the video and/or audio data. In one or more embodiments, the invention provides user interfaces that combine the video feeds and/or events with the user's other social media sites so that the user may manage all their various social media feeds in one place. In one or more embodiments, the invention provides user interfaces that combine real-time chat with one or more video feeds so that users may discuss the video feeds in real time. In one or more embodiments, the invention uses the information from the tags, keywords, GPS coordinates, content analysis of the video and/or audio data, or chat to display relevant, targeted advertisements to the user. In one or more embodiments, the invention determines the amount of bandwidth available to the user who is uploading the video data and adjusts the quality of the encoded video stream to maximize bandwidth usage without exceeding latency limits or dropping data. In one or more embodiments, the remote computer system re-encodes the uploaded video data into one or more different formats. In one or more embodiments, the invention determines the amount of bandwidth available to each user who is viewing the video stream and adjusts the quality of the re-encoded video stream to maximize bandwidth usage without exceeding latency limits or dropping data.

### BRIEF DESCRIPTION OF THE DRAWINGS

The present invention may be understood and its features made apparent to those skilled in the art by referencing the accompanying drawings.

FIG. 1 is a diagram showing components of an Internet video streaming system of an embodiment of the present invention.

FIG. 2 is a diagram showing event grouping features of an embodiment of the present invention.

FIG. 3 is a screenshot showing social media features of an embodiment of the present invention.

FIG. 4 is a screenshot showing social media features of an embodiment of the present invention.

FIG. 5 is a screenshot showing social media features of an embodiment of the present invention.

FIG. 6 is a screenshot showing video stream and advertising features of an embodiment of the present invention.

FIG. 7 is a flowchart showing steps a broadcaster takes to upload data to a server.

FIG. 8 is a flowchart showing steps a receiver takes to stream data from a server.

FIGS. 9A and 9B are a flowchart showing steps a broadcaster and server take to group one or more video streams into events.

### DETAILED DESCRIPTION OF THE INVENTION

In the following description, numerous specific details are set forth to provide a more thorough description of the present invention. It will be apparent to one skilled in the art, however, that the present invention may be practiced without those specific details. In other instances, well-known features have not been described in detail so as not to unnecessarily obscure the invention.

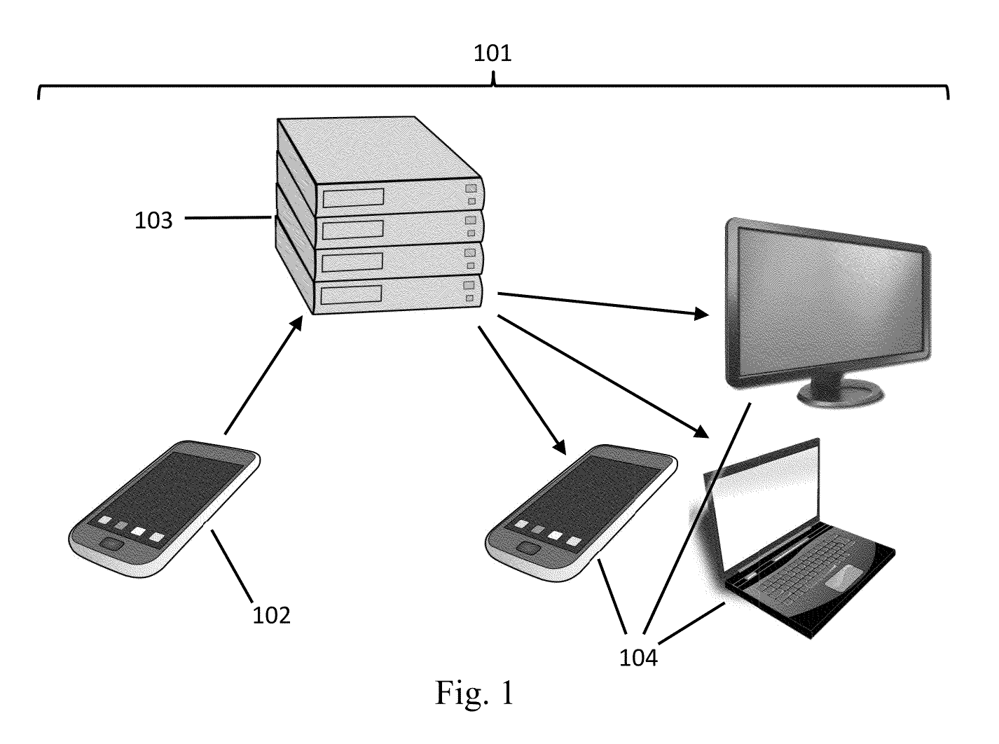

FIG. 1 is a diagram showing components of an Internet video streaming system 101 of an embodiment of the present invention. In one or more embodiments, Internet video streaming system 101 includes one or more broadcasters 102, one or more servers 103, and one or more receivers 104. In one or more embodiments, broadcaster 102 is a mobile phone, a tablet computer, a laptop computer, a desktop computer, or any other electronic device that can acquire or process digital video. In one or more embodiments, server 103 is a computer system that receives, processes, encodes, decodes, and sends digital video over a network. In one or more embodiments, receiver 104 is a mobile phone, a tablet computer, a laptop computer, a desktop computer, a television, or any other electronic device that can receive or display digital video.

In one or more embodiments, one device may combine the features of both broadcaster 102 and receiver 104. For example, a user may capture and broadcast video from a mobile phone, and later use the mobile phone to browse and watch video provided by others. In one or more embodiments, more than one server 103 may be located in a single physical computer system. For example, server 103 may be one of several virtualized hardware and software configurations running on a single physical computer system. In one or more embodiments, server 103 may be located in more than one physical computer system. For example, server 103 may be implemented as a hardware and software configuration running on a cluster of physical computer systems. Further, in one or more embodiments, server 103 may be part of broadcaster 102 or receiver 104 or both. For example, a peer-to-peer Internet video streaming system may omit a central server 103 and perform the tasks of server 103 on one or more broadcasters 102 or receivers 104.

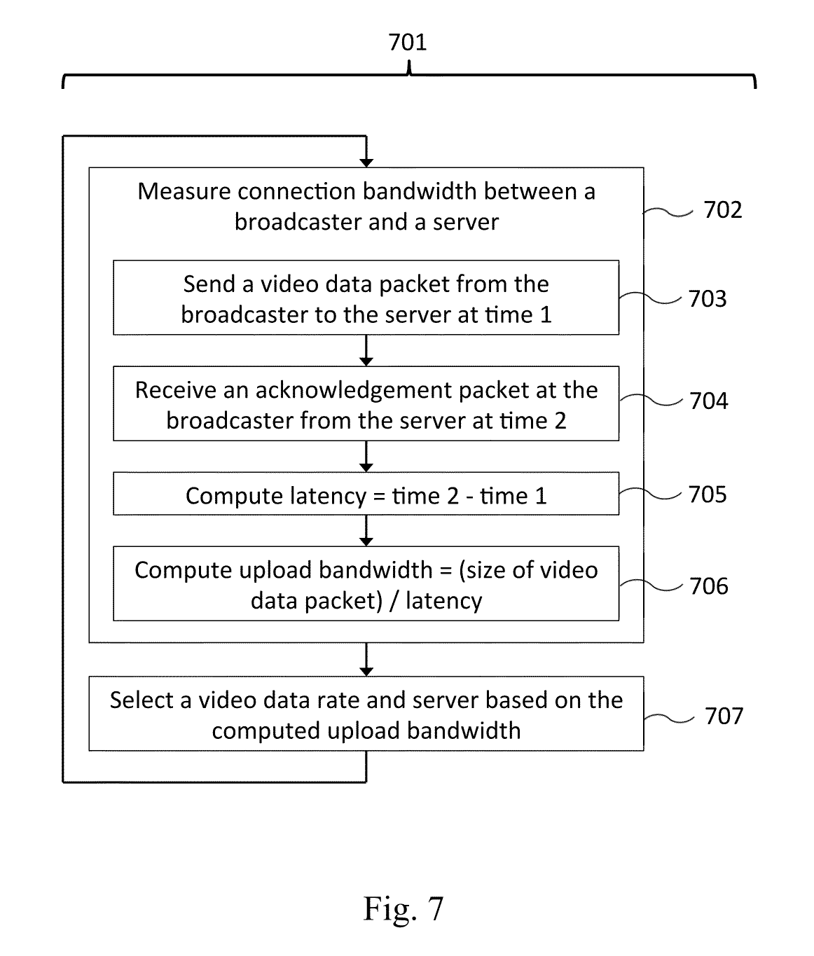

In one or more embodiments, broadcaster 102 includes a camera that captures and stores digital video for subsequent upload to server 103. In one or more embodiments, broadcaster 102 includes a microphone that captures and stores digital audio for subsequent upload to server 103. In one or more embodiments, broadcaster 102 includes one or more other sensors that capture and store digital data, such as scientific data, for subsequent upload to server 103. In one or more embodiments, broadcaster 102 does not capture live video and/or audio, but instead uses previously stored video and/or audio. In one or more embodiments, broadcaster 102 encodes the captured video, audio, or other data into a compressed format (such as MPEG-2, MPEG-4, H.264, or any other format now known or later devised) to make efficient use of bandwidth when uploading. In one or more embodiments, broadcaster 102 splits the video, audio, or other data into a stream of packets of fixed or variable size for transmission over a network. FIG. 1 shows an arrow pointing from broadcaster 102 to server 103, indicating that broadcaster 102 uploads video, audio, or other data packets to server 103. In one or more embodiments, broadcaster 102 and server 103 perform a test to measure the latency and upload bandwidth of broadcaster 102. In one or more embodiments, this latency and bandwidth test is performed with every data packet that is sent between broadcaster 102 and server 103. In one or more embodiments, this latency and bandwidth test is performed less frequently, such as every ten data packets, every second, dynamically in response to delayed or dropped data packets, or only once when the connection between broadcaster 102 and server 103 is established. This latency and bandwidth test is described in more detail below in reference to FIG. 7.

In one or more embodiments, broadcaster 102 uses the latency and bandwidth measurement to select a data rate for encoded video, audio, or other data such that the data rate does not exceed available upload bandwidth and does not exceed allowable latency limits. In one or more embodiments, broadcaster 102 uses the latency and bandwidth measurement to select an optimal data packet size. In one or more embodiments, broadcaster 102 also uses the latency and bandwidth measurement to select a particular server 103 to upload data to. For example, in one or more embodiments, there may be multiple servers 103, each of which is configured to receive a different data rate. Thus, in one or more embodiments, broadcaster 102 selects the server 103 with the highest data rate that does not exceed the broadcaster's measured bandwidth. In one or more embodiments, the server 103 that broadcaster 102 uses to perform the latency and bandwidth measurement may be a different server from the server 103 that broadcaster 102 uploads data to. In one or more embodiments, selection of the particular server 103 for broadcaster 102 to upload data to may be performed by server 103 instead of broadcaster 102.

In one or more embodiments, broadcaster 102 provides user interfaces that allow a user to choose when to capture video and upload the video stream to server 103. In one or more embodiments, the user interfaces allow a user to add tags or keywords to the video stream and choose whether to send other metadata to server 103, such as the GPS coordinates of broadcaster 102. In one or more embodiments, the user interfaces are implemented as a web page hosted by server 103, and broadcaster 102 includes a web browser configured to display the web page. Alternatively, in one or more embodiments, the user interfaces are implemented in application software for mobile platforms, such as the iPhone/iPad, Android, or Blackberry platforms. In one or more embodiments, broadcaster 102 provides user interfaces that allow a user to select and upload pre-recorded video stored on broadcaster 102 as a stream to server 103.

In one or more embodiments, server 103 receives the data uploaded from broadcaster 102. In one or more embodiments, server 103 decodes the data into an intermediate format, such as uncompressed RGB video and PCM audio. In one or more embodiments, server 103 subsequently re-encodes the intermediate format data into one or more distribution formats, such as compressed video and audio in a set of different data rates. In one or more embodiments, server 103 may store any of the data received from broadcaster 103, the intermediate format data, or the re-encoded data for later use.

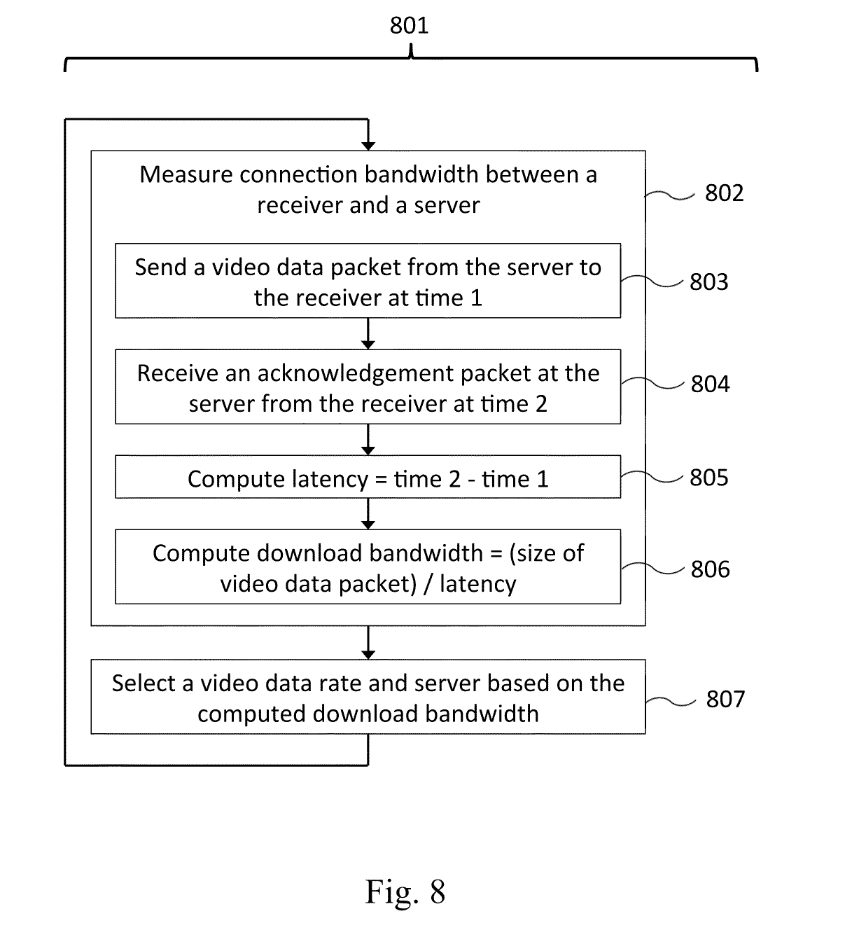

FIG. 1 shows arrows pointing from server 103 to receivers 104, indicating that server 103 uploads video, audio, or other data to one or more receivers 104. In one or more embodiments, server 103 splits the video, audio, or other data into a stream of packets of fixed or variable size for transmission over a network. In one or more embodiments, server 103 and receiver 104 perform a test to measure the latency and download bandwidth of receiver 104. In one or more embodiments, this latency and bandwidth test is performed with every data packet that is sent between server 103 and receiver 104. In one or more embodiments, this latency and bandwidth test is performed less frequently, such as every ten data packets, every second, dynamically in response to delayed or dropped data packets, or only once when the connection between server 103 and receiver 104 is established. This latency and bandwidth test is described in more detail below in reference to FIG. 8.

In one or more embodiments, receiver 104 uses the latency and bandwidth measurement to select a data rate for streamed video, audio, or other data such that the data rate does not exceed available download bandwidth and does not exceed allowable latency limits. In one or more embodiments, receiver 104 uses the latency and bandwidth measurement to select an optimal data packet size. In one or more embodiments, receiver 104 also uses the latency and bandwidth measurement to select a particular server 103 to stream data from. For example, in one or more embodiments, there may be multiple servers 103, each of which is configured to stream one of the different re-encoded distribution formats disussed above. Thus, in one or more embodiments, receiver 104 selects the server 103 with the highest data rate that does not exceed the receiver's measured bandwidth. In one or more embodiments, the server 103 that receiver 104 uses to perform the latency and bandwidth measurement may be a different server from the server 103 that receiver 104 streams data from. In one or more embodiments, selection of the particular data rate, packet size, or server 103 for receiver 104 to stream data from may be performed by server 103 instead of receiver 104.

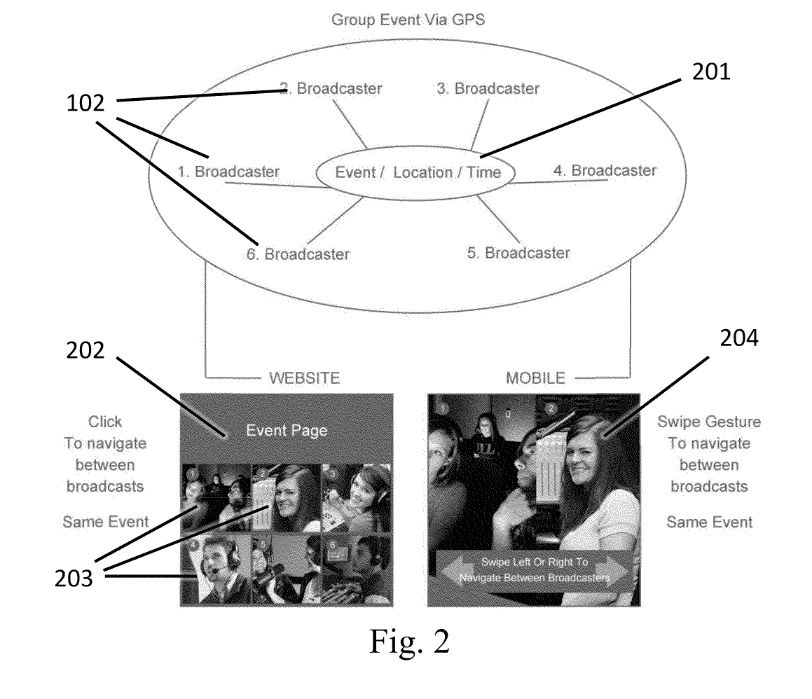

FIG. 2 is a diagram showing the event grouping features of an embodiment of the present invention. In one or more embodiments, multiple broadcasters 102 upload video, audio, or other data acquired from the same event 201 to server 103. In one or more embodiments, event 201 is identified by a specific location, time, or subject. For example, event 201 may be the Emmy awards occurring at the Academy of Television Arts and Sciences on Sep. 22, 2013 at 5:00 pm. Alternatively, event 201 may not have a specific location, such as the 2016 U.S. Presidential election, or may not have a specific time, such as a series of related educational seminars held at a university. In one or more embodiments, server 103 identifies the separate video streams received from broadcasters 102 by metadata that broadcasters 102 send to server 103. In one or more embodiments, the metadata includes user-selected tags or keywords related to the event, such as “Emmy Awards” or “election”. In one or more embodiments, the metadata includes the GPS coordinates of broadcaster 102, which enable server 103 to assign a specific location to each video stream. In one or more embodiments, the metadata is generated by server 103 based on content analysis of the video stream, such as image matching or speech recognition. For example, in one or more embodiments, server 103 might scan the video stream for an image of a speaker at a podium or for a mention of the word “Emmy” and use that information to associate an “Emmy” tag with the video stream.

In one or more embodiments, server 103 uses the metadata to associate one or more events 201 to each video stream. In one or more embodiments, server 103 uses a predefined set of matching criteria for the event, such as a set of keywords or GPS coordinates. In one or more embodiments, server 103 uses a probabilistic model to assign an event to a video stream. For example, server 103 might assign a weight to the GPS coordinates of broadcaster 102 based on the distance from a certain location and a weight to each keyword provided by broadcaster 102 based on how closely it matches a certain set of keywords, and then associate the event with the video stream if the average of the weights exceeds a certain threshold. Alternatively, in one or embodiments, server 103 might observe that many broadcasters 102 are all reporting similar tags, keywords, or GPS coordinates, and dynamically create and assign events that meet or exceed a popularity threshold (determined by, for example, the number of broadcasts of a particular event per unit time, or the derivative or integral of that trend).

In one or more embodiments, receiver 104 provides user interfaces to present events 201 to users of the device. In one or more embodiments, receiver 104 includes a web browser configured to display web page 202 showing information about event 201, including the name, location, and time of the event, associated tags or keywords, and the video streams 203 associated with the event. In one or more embodiments, the user can select a video stream 203 to play that video stream 203 on receiver 104. Alternatively, in one or more embodiments, receiver 104 includes application software 204 configured to show information about event 201, including the name, location, and time of the event, associated tags or keywords, and the video streams 203 associated with the event. In one or more embodiments, application software 204 is provided for mobile platforms, such as the iPhone/iPad, Android, or Blackberry platforms. In one or more embodiments, some video streams 203 asscociated with event 201 may be live, while others may be pre-recorded and stored on, for example, server 103.

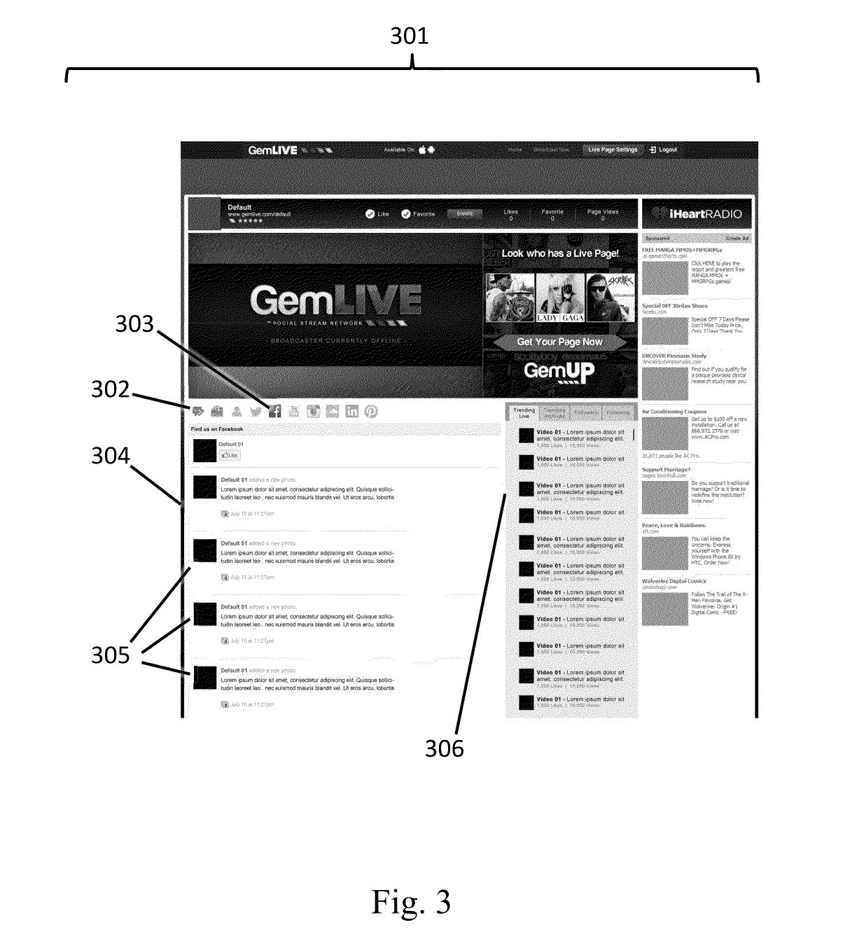

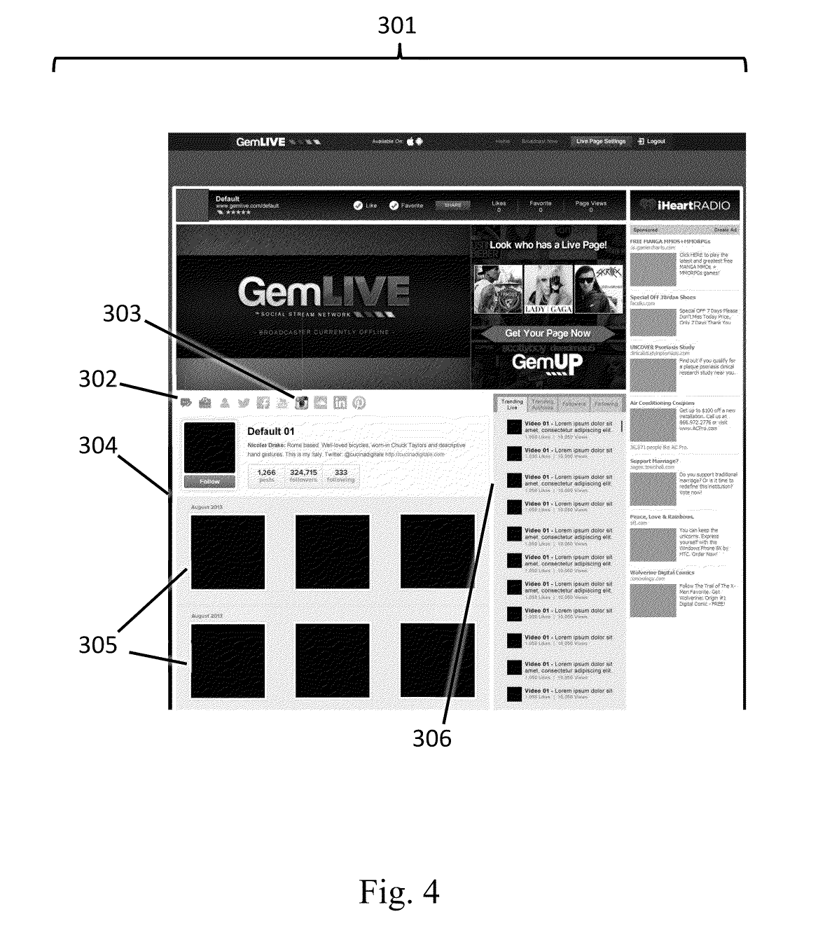

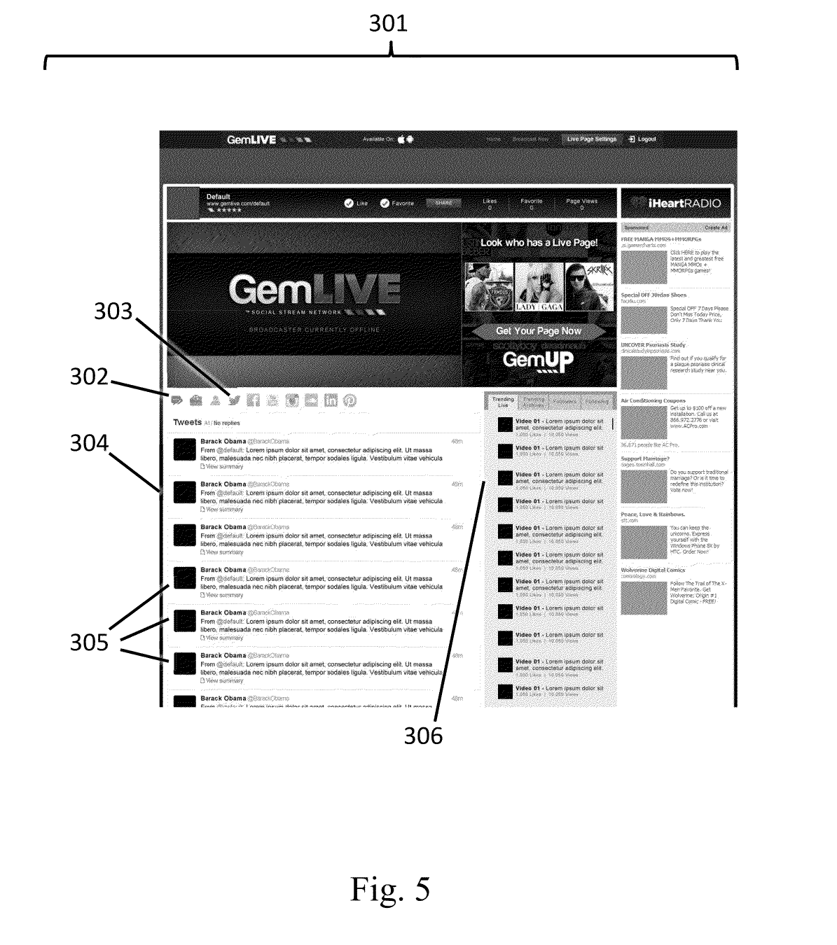

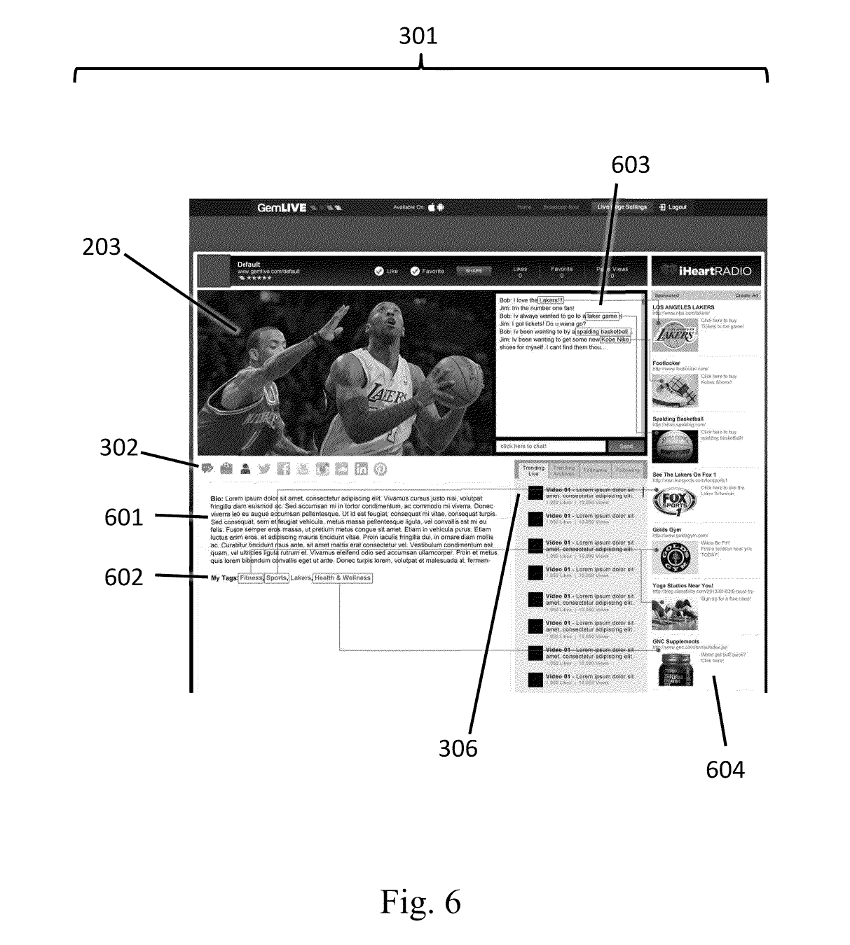

FIGS. 3, 4, and 5 are screenshots showing social media features of an embodiment of the present invention. In one or more embodiments, receiver 104 includes a web browser configured to display web page 301 that combines the video streams 203 and/or contents of event web page 202 with the user's other social media sites so that the user may manage all their various social media feeds in one place. In one or more embodiments, the user's social media feeds are provided using publicly-accessible application programming interfaces (APIs) known in the art, such as the Facebook, Instagram, or Twitter public APIs. In one or more embodiments, social media feed selector 302 displays icons 303 representing each social media feed (for example, Facebook, Instagram, Twitter, etc.). In one or more embodiments, the user can select an icon 303 to display social media content 305 from the corresponding social media feed in feed display area 304. For example, in FIG. 3, icon 303 representing Facebook is selected and feed display area 304 shows social media content 305 from the user's Facebook feed. In FIG. 4, icon 303 representing Instagram is selected and feed display area 304 shows social media content 305 from the user's Instagram feed. In FIG. 5, icon 303 representing Twitter is selected and feed display area 304 shows social media content 305 from the user's Twitter feed. In one or more embodiments, information display area 306 displays general information related to the selected social media feed, such as current trending topics, past trending topics, followers of the user's social media account, and other social media accounts the user is following. In one or more embodiments, web page 301 also displays video streams 203 and/or information associated with event 201, including the contents of event web page 202, that relate to the content of the social media feed (for example, by searching the contents of the social media feed for keywords or tags that match keywords or tags associated with the video streams 203 and/or event 201), as shown and discussed below for FIG. 6. Alternatively, in one or more embodiments, the user interfaces provided in web page 301 may instead be provided in application software for mobile platforms, such as the iPhone/iPad, Android, or Blackberry platforms.

FIG. 6 is a screenshot showing video stream and advertising features of an embodiment of the present invention. In one or more embodiments, receiver 104 includes a web browser configured to display web page 301 that displays video stream 203 or information associated with event 201, including the contents of event web page 202, with a description 601 of the video stream 203 or event 201 and tags 602 assigned to the video stream 203 or event 201. In one or more embodiments, web page 301 provides user interfaces that include real-time chat 603 so that users may discuss the video stream 203 or event 201 as it occurs or at a later time. Alternatively, in one or more embodiments, the user interfaces provided in web page 301 may instead be provided in application software for mobile platforms, such as the iPhone/iPad, Android, or Blackberry platforms.

In one or more embodiments, server 103 and/or receiver 104 use the information from the tags, keywords, GPS coordinates, or chat to display relevant, targeted advertisements 604 to the user via the user interfaces of web page 301. FIG. 6 illustrates the relationship between the advertisements 604 and the content of the tags 602 and chat 603 with lines between some of the advertisements and the text that prompted the selection of that advertisement. Alternatively, in one or more embodiments, the user interfaces provided in web page 301 may instead be provided in application software for mobile platforms, such as the iPhone/iPad, Android, or Blackberry platforms.

FIG. 7 is a flowchart showing a method 701 that a broadcaster 102 uses to upload data to a server 103. The method begins with step 702. In step 702, broadcaster 102 measures the upload bandwidth available from broadcaster 102 to server 103. In one or more embodiments, step 702 is composed of substeps 703 through 706. In substep 703, broadcaster 102 uploads a video data packet to server 103 and records the current time as time 1. From substep 703, the method continues to substep 704. In substep 704, broadcaster 102 receives an acknowledgement packet from server 103 corresponding to the video data packet sent in substep 703 and records the current time as time 2. From substep 704, the method continues to substep 705. In substep 705, broadcaster 102 computes the upload latency (elapsed time), which is the difference between time 2 and time 1. From substep 705, the method continues to substep 706. In substep 706, broadcaster 102 computes the upload bandwidth, which is the size of the video data packet sent in substep 703 divided by the upload latency. Thus, at the end of substep 706, step 702 is complete. From step 702, the method continues to step 707. In step 707, broadcaster 102 selects a video data rate and a server 103 based on the upload bandwidth measured in step 702. In one or more embodiments, if the newly selected video data rate differs from the video data rate that broadcaster 102 is currently using, broadcaster 102 immediately begins encoding new video data at the new rate. In one or more embodiments, if the newly selected server 103 differs from the server 103 that broadcaster 102 is currently connected to, broadcaster 102 disconnects from the current server 103 and connects to the newly selected server 103. From step 707, the method continues to step 702 and broadcaster 102 continues sending video data packets to server 103. Alternatively, in one or more embodiments, any of steps 702 through 707 may be performed on any combination of broadcaster 102, server 103, or any other computer system. For example, server 103 might calculate the upload bandwidth of broadcaster 102 in step 702 and report that result to broadcaster 102 for its use in step 707.

FIG. 8 is a flowchart showing a method 801 that a receiver 104 uses to stream data from a server 103. The method begins with step 802. In step 802, receiver 104 measures the download bandwidth available from server 103 to receiver 104. In one or more embodiments, step 802 is composed of substeps 803 through 806. In substep 803, server 103 uploads a video data packet to receiver 104 and receiver 104 records the current time as time 1. From substep 803, the method continues to substep 804. In substep 804, server 103 receives an acknowledgement packet from receiver 104 corresponding to the video data packet sent in substep 803 and receiver 104 records the current time as time 2. From substep 804, the method continues to substep 805. In substep 805, receiver 104 computes the download latency (elapsed time), which is the difference between time 2 and time 1. From substep 805, the method continues to substep 806. In substep 806, receiver 104 computes the download bandwidth, which is the size of the video data packet sent in substep 803 divided by the download latency. Thus, at the end of substep 806, step 802 is complete. From step 802, the method continues to step 807. In step 807, receiver 104 selects a video data rate and a server 103 based on the download bandwidth measured in step 802. In one or more embodiments, if the newly selected server 103 differs from the server 103 that receiver 104 is currently connected to, receiver 104 disconnects from the current server 103 and connects to the newly selected server 103. From step 807, the method continues to step 802 and server 103 continues sending video data packets to receiver 104. Alternatively, in one or more embodiments, any of steps 802 through 807 may be performed on any combination of server 103, receiver 104, or any other computer system. For example, server 103 might calculate the download bandwidth of receiver 104 in step 802 and report that result to receiver 104 for its use in step 807.

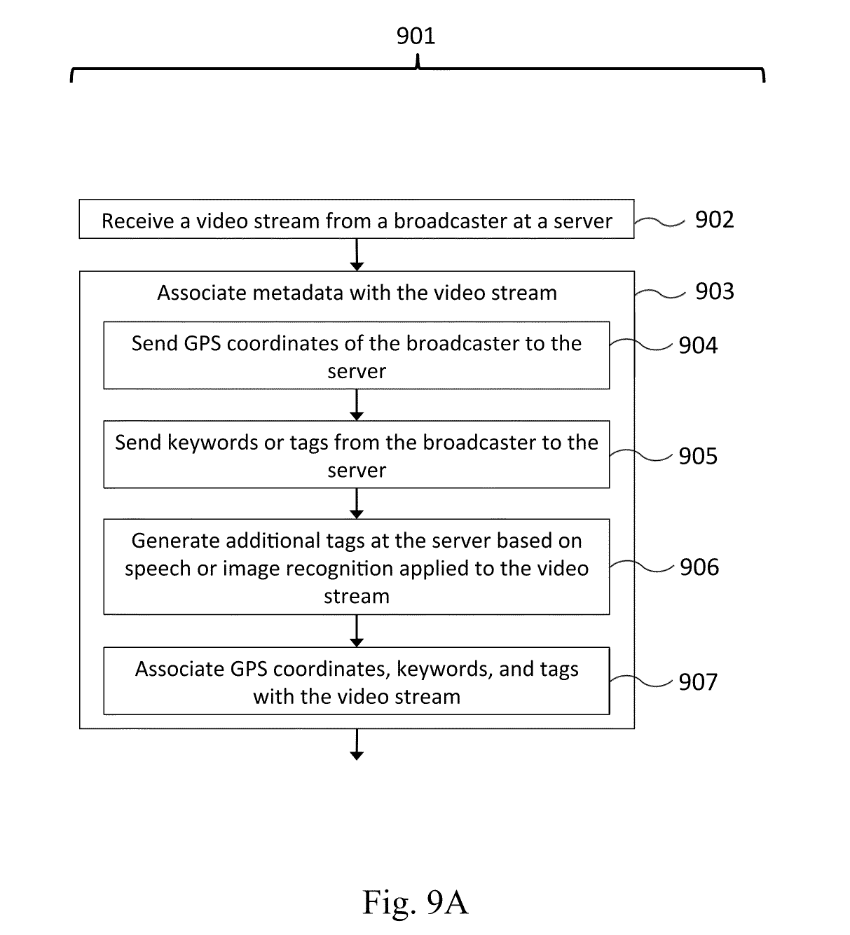

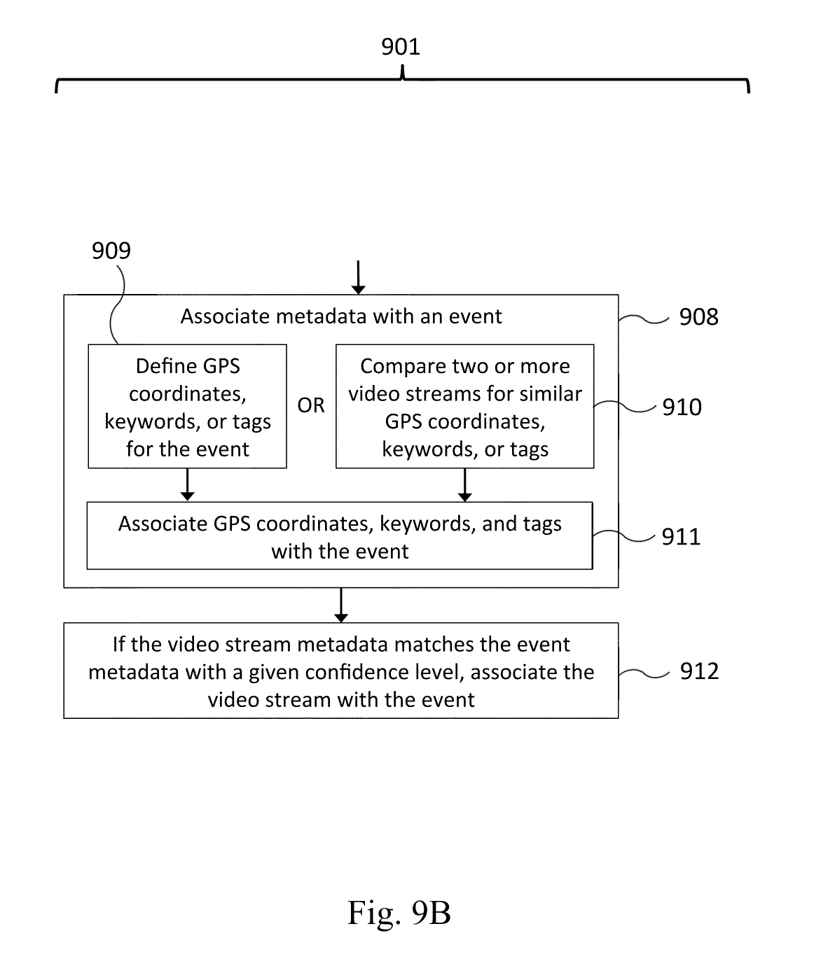

FIGS. 9A and 9B are a flowchart showing a method 901 that a broadcaster 102 and server 103 use to group one or more video streams into events. The method begins with step 902. In step 902, server 103 receives a video stream from broadcaster 102. From step 902, the method continues to step 903. In step 903, server 103 associates metadata with the video stream received in step 902. In one or more embodiments, step 903 is composed of substeps 904 through 907. In substep 904, broadcaster 102 sends its GPS coordinates to server 103. From substep 904, the method continues to substep 905. In substep 905, broadcaster 102 sends keywords or tags selected by the user to server 103. From substep 905, the method continues to substep 906. In substep 906, server 103 performs content analysis of the video stream (for example, speech recognition or image recognition using methods known in the art) to generate additional keywords or tags. From substep 906, the method continues to substep 907. In substep 907, server 103 associates the GPS coordinates, keywords, and tags with the video stream (for example, by storing the GPS coordinates, keywords, and tags in a database table along with a reference to the video stream). Thus, at the end of substep 907, step 903 is complete.

From step 903, the method continues to step 908. In step 908, server 103 associates metadata with an event known to server 103 (for example, an event stored as an entry in a database table). In one or more embodiments, step 908 is composed of substeps 909 through 911. In substep 909, GPS coordinates, keywords, and/or tags are defined by, e.g., a system administrator or operator of server 103. Alternatively, in substep 910, GPS coordinates, keywords, and/or tags are generated dynamically by server 103 by comparing the metadata of two or more video streams (for example, if identical or similar GPS coordinates, keywords, and/or tags are associated with different video streams, server 103 selects that identical or similar metadata). From either substep 909 or substep 910, the method continues to substep 911. In substep 911, server 103 associates the GPS coordinates, keywords, and tags with the event (for example, by storing the GPS coordinates, keywords, and tags in a database table along with a reference to the event). Thus, at the end of substep 911, step 908 is complete. From step 908, the method continues to step 912. In step 912, server 103 compares the video stream metadata from step 903 and the event metadata from step 908. If there is a match between the video stream metadata and the event metadata, server 103 associates the video stream with the event (for example, by storing a reference to the video stream in a database table along with a reference to the event). In one or more embodiments, server 103 may assign a confidence level to similar, but inexact, matches between certain video stream metadata and certain event metadata to broaden the scope of possible matches. In one or more embodiments, server 103 combines the results of all the comparisons into a single confidence number (e.g., by computing a weighted average of the assigned confidence levels). In one or more embodiments, server 103 associates the video stream with the event if the confidence number exceeds a confidence threshold. In one or more embodiments, the confidence threshold is defined by, e.g., a system administrator or operator of server 103 to maximize the accuracy of the matching of video streams to relevant events.

Thus one or more embodiments of an Internet video streaming system has been disclosed. Although the present invention has been described with respect to certain specific embodiments, it will be clear to those skilled in the art that the inventive features of the present invention are applicable to other embodiments as well, all of which are intended to fall within the scope of the present invention. For example, the bandwidth detection and bitrate adjustment functionality may be used with other types of data streams, such as audio data or scientific data from real-time sensor measurements. Further, the Internet video streaming system might provide additional functionality, such as video editing, screen sharing, or other types of data transfer. Other variations of and uses for various aspects of the present invention will be apparent to those of skill in the art.

APPENDIX A
PARTIAL LISTING OF CODE

```
BroadcastBW.as
package client
{
  public class BroadcastBW
  {
    public var nc:NetConnection;
    public var result;
    public var packet;
    public var ro;
    public function BroadcastBW( )
    {
      nc = new NetConnection( );
      nc.addEventListener(NetStatusEvent.NET_STATUS,
        netConnectionStatusHandler);
      ro = new Responder(onResult);
      result = new Object;
      result.latency = 0;
      result.cumLatency = 1;
      result.bwTime = 0;
      result.count = 0;
      result.sent = 0;
      result.kbitUp = 0;
      result.deltaUp = 0;
      result.deltaTime = 0;
      result.pakSent = new Array( );
      result.pakRecv = new Array( );
      result.beginningValues = { };
      nc.objectEncoding = ObjectEncoding.AMF0;
      var ncClientObj:Object = new Object( );
      nc.client = ncClientObj;
      ncClientObj.onBWDone = BWDone;
      ncClientObj.onBWCheck = ncOnBWCheck;
      packet = new Array( );
      for (var i=0; i<1200; i++)
      {
        packet[i] = Math.random( );
      }
      nc.connect(″rtmp://streaming.linqilive.com/bwcheck″);
    }
    public function BWCheck( )
    {
      nc.call(″onClientBWCheck″, ro, null);
    }
    public function netConnectionStatusHandler(e:NetStatusEvent):
    void
  {
    switch (e.info.code)
    {
      case ″NetConnection.Connect.Success″:
        BWCheck( );
        break;
      case ″NetConnection.Connect.Failed″:
        trace(″Netconnection Has Failed″)
        break;
    }
  }
  public function BWDone( )
  {
    trace(″Done″);
  }
  public function ncOnBWCheck( )
  {
    trace(″Starting″);
  }
  public function onClientResponse( )
  {
    trace(″response″);
  }
  function onResult(arg)
  {
    var now = (new Date( )).getTime( )/1;
    if(result.sent == 0)
    {
      result.beginningValues = arg;
      result.beginningValues.time = now;
      result.pakSent[result.sent++] = now;
      nc.call(″onClientBWCheck″, ro, now);
    }
    else
    {
      result.pakRecv[result.count] = now;
      result.count++;
      var timePassed = ( now − result.beginningValues.time );
      if (result.count == 1)
      {
        result.latency = Math.min(timePassed, 800);
        result.latency = Math.max(result.latency, 10);
        result.overhead = arg.cOutBytes −
          result.beginningValues.cOutBytes;
        result.pakSent[result.sent++] = now;
        nc.call(″onClientBWCheck″, ro, now, packet);
      }
      if ( (result.count >= 1) && (timePassed < 1000))
      {
        result.pakSent[result.sent++] = now;
          result.cumLatency++;
          nc.call(″onClientBWCheck″, ro, now, packet);
        }
        else if (result.sent == result.count)
        {
          if ( this.latency >= 100 )
          {
            if ( result.pakRecv[1] − result.pakRecv[0] > 1000 )
            {
              result.latency = 100;
            }
          }
          packet.length = 0;
          var stats = arg;
          var deltaUp = (stats.cOutBytes −
          result.beginningValues.cOutBytes)*8/1000;
          var deltaTime = ((now − result.beginningValues.time) −
          (result.latency * result.cumLatency) )/1000;
          if ( deltaTime <= 0 ) deltaTime = ( now −
          result.beginningValues.time) / 1000;
          var kbitUp = Math.round(deltaUp/deltaTime);
          return kbitUp;
        }
      }
    }
  }
}
broadcast.as
import flash.events.NetStatusEvent;
import flash.media.Camera;
import flash.media.H264Level;
import flash.media.H264Profile;
import flash.media.H264VideoStreamSettings;
import flash.media.Video;
import com.client.BroadcastBW;
var coolBox:MyCoolBox = new MyCoolBox( );
private var ns_out:NetStream;
private var mic:Microphone;
private var nc:NetConnection;
private var cam:Camera;
private var myCam:Video;
public var streamname:String;
public var abw:int;
public var aquality:int;
public var rtmpser:string;
public var connected:Boolean;
public function LoginresultHandler(event:ResultEvent):void
{
  setCurrentState(″Broadcast″);
  var bw:BroadcastBW = new BroadcastBW( );
  connected = false;
  if(bw <= 400)
  {
    rtmpser = ″highlat.linqlive.com″
    aquality = 70;
    abw = Math.round(bw * .70);
  }
  else if(bw > 400 && bw <= 800)
  {
    rtmpser = ″medlat.linqlive.com″
    aquality = 80;
    abw = Math.round(bw * .70);
  }
  else if(bw > 800)
  {
    rtmpser = ″lowlat.linqlive.com″
    aquality = 85;
    abw = Math.round(bw * .80);
  }
  cam = Camera.getCamera( );
  cam.setQuality(abw,aquality);
  cam.setMode(640, 360, 25, true);
  cam.setKeyFrameInterval(2);
  myCam = new Video(640,360);
  myCam.attachCamera(cam);
  uic.addChild(myCam);
}
private function VideoConnect( ):void
{
  if(connected == false)
  {
    nc = new NetConnection( );
    nc.client=this;
    nc.addEventListener(NetStatusEvent.NET_STATUS,
    netStatusHandler);
    nc.connect(″rtmp://″ + rtmpser + ″/videochat″);
    connected = true;
  }
  else
  {
    this.ns_out.close( );
    nc.close( );
    connected = false;
  }
}
private function netStatusHandler(event:NetStatusEvent):void
{
  switch (event.info.code)
  {
    case ″NetConnection.Connect.Success″:
      publishStream( );
      break;
    case ″NetStream.Connect.Closed″:
      trace(″Net stream Closed″)
      break;
    case ″NetConnection.Connect.Failed″:
      trace(″Net Connection Failed″)
      break;
    case ″NetStream.Play.Stop″:
      trace(″Net stream Stopped″)
      break;
    case ″NetStream.Publish.Start″:
      trace(″publishing started″)
      break;
    case ″NetStream.Publish.BadName″:
      trace(″Net Stream Duplicate Name″)
      break;
  }
}
private function publishStream( ):void
{
  streamname = ″mp4:″ + domain + ″.f4v″; // newer Versions
  have Random
    Timpstamps at the end to stop name dups // Server Does not
    overwrite
  mic = Microphone.getMicrophone( );
  mic.setSilenceLevel(0);
  mic.rate = 11;
  mic.gain = 50; // increase this to boost the microphone audio
  mic.codec = SoundCodec.SPEEX; // this is important
  mic.encodeQuality = 5;
  mic.framesPerPacket = 2;
  ns_out = new NetStream(nc);
  var h264Settings:H264VideoStreamSettings = new
  H264VideoStreamSettings( );
  h264Settings.setProfileLevel(H264Profile.BASELINE,
  H264Level.LEVEL_3_1);
  ns_out.videoStreamSettings = h264Settings;
  ns_out.videoStreamSettings = h264Settings;
  ns_out.attachCamera(cam);
  ns_out.attachAudio(mic);
  ns_out.publish(streamname, ″live″);
  var metaData:Object = new Object( );
  metaData.codec = ns_out.videoStreamSettings.codec;
  metaData.profile = h264Settings.profile;
  metaData.level = h264Settings.level;
  metaData.fps = cam.fps;
  metaData.bandwith = cam.bandwidth;
  metaData.height = cam.height;
  metaData.width = cam.width;
  metaData.keyFrameInterval = cam.keyFrameInterval;
  metaData.copyright = ″Linqlive,2013″;
  ns_out.send(″@setDataFrame″, ″onMetaData″, metaData);
  // LogStream( );
}
player.as
package
{
  import flash.display.Loader;
  import flash.display.LoaderInfo;
  import flash.display.Sprite;
  import flash.display.StageAlign;
  import flash.display.StageQuality;
  import flash.display.StageScaleMode;
  import flash.events.Event;
  import flash.net.URLRequest;
  import flash.system.Capabilities;
  import org.osmf.elements.ImageLoader;
  import org.osmf.events.LoadEvent;
  import org.osmf.events.MediaPlayerCapabilityChangeEvent;
  import org.osmf.events.MediaPlayerStateChangeEvent;
  import org.osmf.events.PlayEvent;
  import org.osmf.layout.LayoutMetadata;
  import org.osmf.layout.ScaleMode;
  import org.osmf.media.MediaPlayerSprite;
  import org.osmf.media.URLResource;
  [SWF(width=″640″, height=″360″)]
  public class ifclp extends Sprite
  {
    public var user:String = root.loaderInfo.parameters.user;
    public var rtmpserv:String = root.loaderInfo.parameters.rtmpserv;
    // Server Side Handles Dynamic Bitrate Stream.
    public var urlstring:String = ″http://″ + rtmpserv +
      ″:1935/videochat/″+user+″/manifest.f4m″;
    public var tvURL:URLResource = new URLResource(urlstring);
    public var player:MediaPlayerSprite = null;
    public var oimg:Loader;
    public function ifclp( )
    {
      addEventListener(Event.ADDED_TO_STAGE, init);
    }
    public function init(event:Event):void
    {
      var oimg:Loader= new Loader( );
      var fileRequest:URLRequest = new
        URLRequest(″http://www.ifanme.com/images/offline.png″);
      oimg.load(fileRequest);
      stage.addChild(oimg);
      player = new MediaPlayerSprite( );
      player.resource = tvURL;
      player.mediaPlayer.autoPlay = true;
      player.mediaPlayer.addEventListener(
        MediaPlayerCapabilityChangeEvent.CAN_PLAY_CHANGE,
        onCanPlayChange);
      player.mediaPlayer.addEventListener(PlayEvent.
      PLAY_STATE_CHANGE,
        onPlayStateChange);
    }
    public function onCanPlayChange(
      e:MediaPlayerCapabilityChangeEvent):void
    {
      stage.removeChildAt(1);
      stage.scaleMode = StageScaleMode.NO_SCALE;
      stage.align = StageAlign.TOP_LEFT;
      stage.quality = StageQuality.HIGH;
      var layout:LayoutMetadata = new LayoutMetadata( );
      layout.scaleMode = ScaleMode.LETTERBOX;
      layout.height = 360;
      layout.width = 640;
      player.media.addMetadata(LayoutMetadata.
      LAYOUT_NAMESPACE, layout);
      addChild(player);
    }
    private function onPlayStateChange(e:PlayEvent):void
    {
      if(!player.mediaPlayer.playing)
      {
        var oimg:Loader= new Loader( );
        var fileRequest:URLRequest = new
          URLRequest(″http://www.ifanme.com/images/offline.png″);
        oimg.load(fileRequest);
        stage.addChild(oimg);
      }
    }
  }
}
```

1. A method, comprising:
encoding a first video stream on a first device,
sending the first video stream from the first device to a second device,
re-encoding the first video stream on the second device into one or more second video streams, and
sending one or more of the second video streams to a third device;
wherein the first device adjusts the bitrate of the first video stream to maximize network bandwidth usage without exceeding a latency limit.
